(19) United States
(12) Patent Application Publication
(10) Pub. No.: US 2007/0180056 A1
(43) Pub. Date: Aug. 2, 2007

(54) DOMAIN NAME REGISTRATION SYSTEM AND METHODS FOR OPEN TOP LEVEL DOMAIN ENVIRONMENT

(76) Inventor: Elias ASSAD, Ottawa (CA)

Correspondence Address: VICTORIA DONNELLY, PO BOX 24001, HAZELDEAN RPO, KANATA, ON, K2M 2C3, US

(21) Appl. No.: 11/669,139

(22) Filed: Jan. 30, 2007

Related U.S. Application Data
(60) Provisional application No. 60/763,393, filed on Jan. 31, 2006.

(51) Int. Cl. G06F 15/16

(52) U.S. Cl. 709/217

(57) ABSTRACT

The invention proposes improved methods and system for registering top level domains (TLDs) and second (or lower) level domains (SLDs) suitable for open top level domain environment having a large, generally unlimited, number of TLDs. The method comprises the step of categorizing the TLD to be registered by assigning at least one series of labels to the TLD, which preferably form a hierarchy of TLD categories. A method for registering lower level domains in an open TLD environment is provided, where verifying for potential existing conflicts with existing TLDs is performed. A corresponding system for registering TLDs and lower level domains in an open TLD environment is also provided.

### FIELD OF THE INVENTION

The invention relates to registering domain names, and in particular, to domain name registration system and methods suitable for open top level domain environment.

### RELATED APPLICATIONS

The current invention relates to the previously filed application to the same inventor (Elias Assad) as described Patent Cooperation Treaty (PCT) application number PCT/CA2005/000453 (Publication Number WO 2005/093999 A1) filed on 29 Mar. 2005 entitled “SYSTEMS AND METHODS OF REGISTERING AND UTILIZING DOMAIN NAMES”, which is incorporated herein by reference.

### BACKGROUND OF THE INVENTION

By open top level domain environment, we will mean the environment, which provides the creation and use of unlimited number of top-level domain (TLD) names that are created on demand, in parallel with those specified by the Internet Corporation for Assigned Names and Numbers (ICANN) or other authority authorized to approve standardized top-level domain names, as described in detail in the PCT application cited above.

For convenience, a brief summary of the PCT application is presented below.

Conveniently, the open top level domain environment may have a domain name registration system, which uses a predefined function that maps the TLD name to an Internet Protocol (IP) address, herein termed TLDIP address, which belongs to a set of IP addresses reserved a priori for a group of name servers. If the TLD name has not been registered before, the registration system assigns the TLDIP address to a network interface on a name server computer, which would then become the designated TLD name server for said TLD.

A domain name server (DNS) extension software running on a client computer system uses said predefined function when a user enters an Internet address containing a non-ICANN TLD name on a client computer in order to compute the IP address of the corresponding TLD name server and access it, thereby enabling browsers and other connectivity devices or systems to access and/or utilize non-ICANN top-level domains.

Conveniently, the user downloads the DNS extension software program to a client computer system that includes WinSock2 or equivalent service providing an interface to the Name Space Provider (s) and Layered Service Provider (s) to enable utilization of the non-ICANN domain addresses.

The DNS extension software may be downloaded or installed from a floppy disk, CD-ROM, via a network, such as the Internet, or may be pre-installed on the client computer.

The downloaded DNS extension software processes non-ICANN address requests (those addresses that do not end in “.com”, “.net”, “.org”, “.mil”, an ICANN-defined two letter country code, or other ICANN specified TLDs) received from a browser or other application by computing the IP address of the TLD name server from the characters of the TLD name.

For example, a user downloads the DNS extension software and then, using the browser, requests a non-ICANN address, such as “John.Doe”. As on conventional systems, the process begins with the browser requesting the operating system services to identify the numeric location of the requested website. In searching for the server location, the operating system utilizes the DNS extension software, which resolves the domain name and returns the IP address that identifies the requested website.

Alternatively, the cited above PCT application provides a process for accessing the non-ICANN Internet addresses through the user's ISP. This approach is performed in a manner transparent to the consumer, as it does not require the DNS extension software to be installed on the user's system. Advantageously, utilizing such non-ICANN TLDs attracts more consumers. By way of example, the user enters or provides a browser with a non-ICANN Internet address (e.g. “John.Doe”) of a website or other network resource. The browser, in communication with the operating system, sends an IP address lookup request to the ISP's domain name system server. If the domain name system server implements the methods disclosed herein, applying a predefined function to compute the IP address of the TLD name server, it then locates the IP address representing the server of the requested page.

Thus, it is contemplated that the number of TLDs in the open TLD environment can be extremely large, potentially measured in tens or hundreds of thousands or larger. Accordingly, the number of Second level domains (SLDs), which are one level below the TLDs, can be accordingly much larger, let alone the number of third, fourth etc level domains in the domain name hierarchy. This makes the process of registering a domain name very time-consuming and inconvenient for a user, and possibly not always reliable.

Accordingly, the development of an improved system and methods for registering TLDs, SLDs and lower level domains in the open top level domain environment is required.

### SUMMARY OF THE INVENTION

The invention proposes improved methods and system for registering top level domains (TLDs) and second (or lower) level domains (SLDs) suitable for open top level domain environment.

According to one aspect of the present invention, there is provided a method for registering a second level domain “SLD_X”, in an open Top level domain (TLD) environment having a large, generally unlimited, number of TLDs, the method comprising the steps of:
(a) identifying potential conflict between the “SLD_X” and existing TLD registrations;
(b) arranging TLDs, including “SLD_X.TLD” domain names, into a domain name category tree having a hierarchy of domain name categories, sub-categories etc.;
(c) displaying the domain name category tree, comprising marking all “SLD_X.TLD” domain names in the hierarchy of domain name categories that have potential conflict as identified in the step (a); and
(d) in the displayed and marked domain name category tree, selecting one or more domain names “SLD_X.TLD” for registration, the selected domain names not being marked as having potential conflict in the step (c); and
(e) registering the selected one or more domain names.

According to another aspect of the invention there is provided a system for registering the second level domain (SLD) in an open top level domain (TLD) environment, comprising:
a computer;
a web site for receiving an input data with regard to a domain name that is requested to be registered; and
a program executing on said computer for performing the steps of the registration method described above.

According to yet another aspect of the present invention there is provided a web site for registering a SLD in an open TLD environment, comprising:
a link on the web site causing a computer program code associated with the web-site and stored in a computer memory to be executed so as to provide a data input means for receiving an input data with regard to a requested domain name to be registered and to perform the registration process according to the steps of the method described above.

According to one more aspect of the present invention there is provided a method for registering a Top level domain (TLD) in an open Top level domain (TLD) environment having a large, generally unlimited, number of TLDs, the method comprising the step of categorizing the TLD to be registered by assigning at least one series of labels to the TLD. The labels are optionally forming a hierarchy of TLD categories.

The system for registering top level domains and lower level domains for open top level domain environment comprises a general purposes or specialized computer, having memory for storing instructions for executing the steps of the methods described above.

Thus, improved methods and system for registering top level domains (TLDs) and second (or lower) level domains (SLDs) suitable for open top level domain environment have been provided.

### BRIEF DESCRIPTION OF THE DRAWINGS

Embodiments of the invention are described below by way of example only. Reference is made to the accompanying drawings in which:

FIG. 1 shows a flowchart, illustrating a method for SLD registration in the open TLD environment;

FIG. 2 shows a flowchart illustrating the step 18 of checking potential conflicts of the method for SLD registration of FIG. 1;

FIG. 3 shows one form of arranging and displaying a domain name category tree in the step 20 of the method for SLD registration of FIG. 1; and

FIG. 4 shows a flowchart, illustrating a method for TLD registration in the open TLD environment.

### DETAILED DESCRIPTION OF THE EMBODIMENTS OF THE INVENTION

In the first embodiment of the present invention, a method for registering a SLD in the open TLD environment is provided. It is assumed that a large number TLDs has been already registered, with the total number of TLDs, in principle, being unlimited according to the concept of the open TLD environment as described above in the background section.

For further clarity, in the domain name “John.Doe”, “Doe” is the TLD, and “John” is the SLD. In general, any two level domain name including top and second level domains, can be written in the form “SLD_X.TLD_Y”.

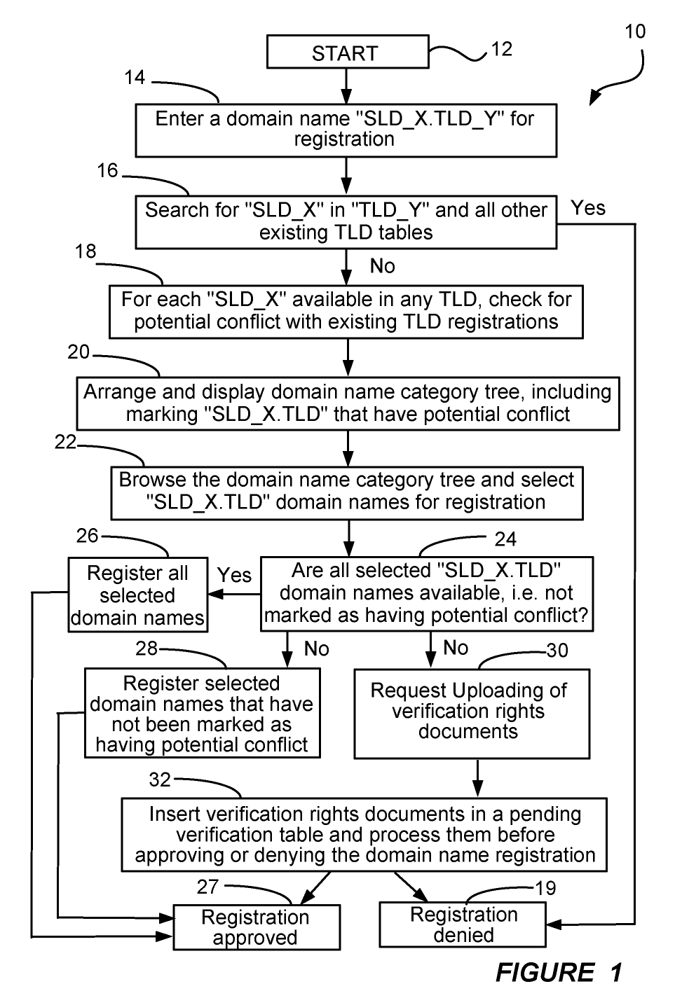

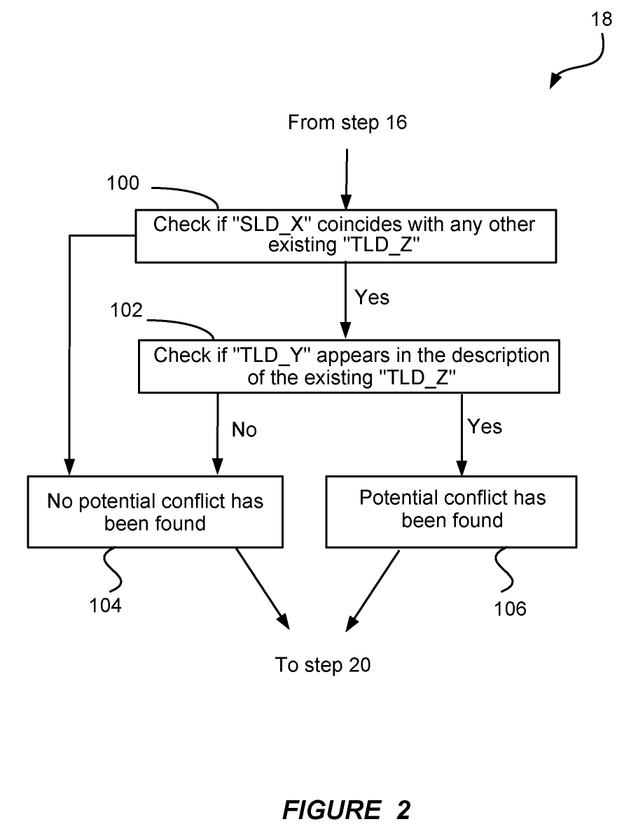

The method for registering a SLD in the open TLD environment according to the first embodiment of the invention is illustrated by flowchart 10 in FIG. 1. Upon Start (box 12), a user enters a domain name “SLD_X.TLD_Y” to be registered on a registration website (box 14), and presses a search key, thus making a registration system to perform a search for “SLD_X” word/number combination in the “TLD_Y” table of existing domains, as well as other existing TLD tables (box 16). If the search is successful (exit “No” from box 16), the registration system proceeds to step 18, otherwise (exit “Yes” from box 16), the domain name registration is denied and the registration procedure is terminated (box 19). In the step 18 of the flowchart 10, the registration system searches for potential conflicts, namely for each SLD_X available in any TLD, it checks for potential conflicts with existing TLD registrations, i.e. if “SLD_X” has been already registered in TLD by someone else, the step 18 will be described in more detail below with regard to FIG. 2.

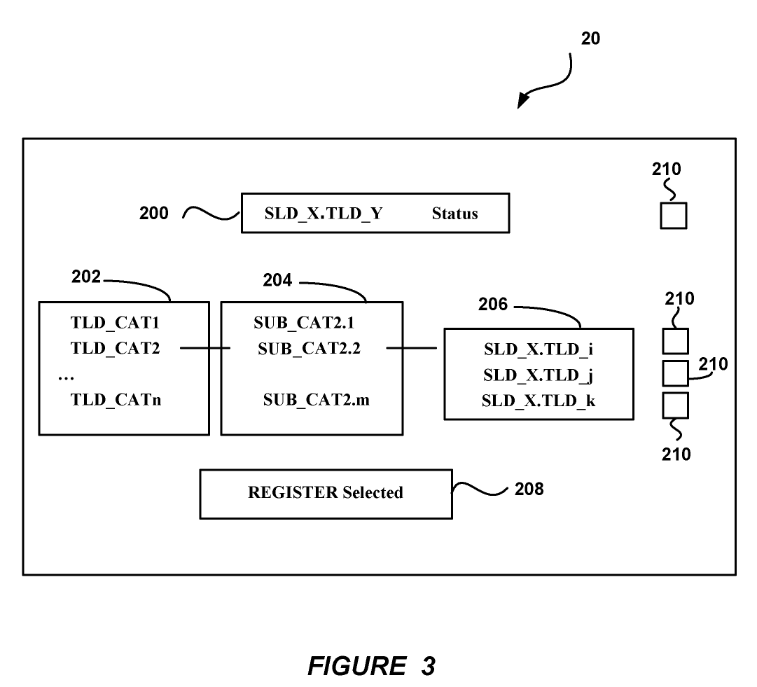

After performing the step 18, the registration system proceeds to step 20 of displaying a domain name directory (hierarchy) in the from of domain name category tree, including marking of the TLDs and “SLD_X.TLD” combinations, which have a potential conflict with the requested “SLD_X.TLD_Y” domain name registration. The marking can be done by using color, or any other visual and/or audio means or signals, which can convey a message regarding the potential conflict to the user. One possible arrangement of the domain name category tree is shown in FIG. 3, which shows the status of the requested “SLD_X.TLD_Y” domain name registration, and will be described in greater detail below. The user is allowed to browse the domain name category tree and to select any TLD under which he/she wants to register the “SLD_X”, including but not limited to the initially selected “SLD_X.TLD_Y” domain name (box 22). If all selected domain names are available, i.e. not marked as having potential conflicts in the step 20 above (exit “Yes” from box 24), the registration system proceeds to the registration of the selected domain names, i.e. selected available combinations of “SLD_X.TLD” (box 26), thus the registration of the domain names being approved and the registration process being terminated (box 27). If any of the selected “SLD_X.TLD” domain names has been marked as having a potential conflict in the step 20 above (exit “No” from box 24), the registration system proceeds to steps 28 and 30, respectively registering the selected domain names that have not been marked as having a potential conflict (box 28), and requesting the submission (uploading) of verification rights documents to verify rights for the remaining selected domain names, which have been marked as having a potential conflict (box 30). Thus, after the step 28, the registration of the domain names is approved and the registration procedure is terminated (box 27), while after the step 30, the uploaded verification rights documents are inserted in a pending verification table and processed before confirming or declining the requested domain name registration to the user (box 32), before the registration process is terminated (box 19).

The method illustrated by the flowchart 10 is performed in a client-server architecture. For example, the steps 16, 18, 24, 28, 30 and 32 of the above noted method are conveniently performed on a server, while the steps 14, 20, 22 are performed on a user computer by, e.g. entering, displaying, browsing etc, certain information on the registration website by using a user's browser.

FIG. 2 shows a flowchart illustrating the step 18 of checking potential conflicts of the method for SLD registration of FIG. 1 in more detail. First, a verification is performed if the “SLD_X” coincides with any other existing “TLD_Z” (box 100). It not (exit “No” from box 100), no conflict has been found (box 104). If it is so (exit “Yes” from box 100), another verification is performed, namely checking if “TLD_Y” appears in the description of the existing “TLD_Z” (box 102). The description of the “TLD_Z” may comprise a summary of the “TLD_Z” prepared by the owner and/or edited by a registrar of domain names, and/or a description of goods or services of the trademark associated with “TLD_Z”, or other. If “TLD_Y” appears in the description of the “TLD_Z” (exit “Yes” from box 102, potential conflict has been found (box 106). If not (exit “No” from box 102), then no potential conflict has been found (box 104). Accordingly, the step 18 is completed, and the method further proceeds to the step 20 in the flowchart 10 of FIG. 1.

FIG. 3 shows one form of arranging and displaying a domain name category tree in the step 20 of the method for SLD registration of FIG. 1, including displaying the “SLD_X.TLD_Y” status 200 for registration. The domain name category tree shown in the step 20 includes a hierarchy of domain name categories labeled as 202, 204 and 206 in FIG. 3 (only three levels in the hierarchy being shown), wherein the first level in the domain name hierarchy (box 202) shows a list of categories that TLDs are saved under (TLD_CAT1, TLD_CAT2, . . . TLD_CATn), with the next lower level in the hierarchy (box 204) showing respective sub-categories for each of the first level category, i.e. sub-categories SUB_CAT2.1, SUB_CAT2.2, . . . SUB_CAT2.m (box 204) corresponding to the first level category TLD_CAT2 of box 202. Accordingly, each of the sub-categories in box 204 may be further expended into yet lower level sub-sub-categories, etc., as it may be appropriate. In the example of FIG. 3, the sub-category SUB_CAT2.2 is shown to be expanded into a list of domain names including second level domain “SLD_X” and various TLDs such as “TLD_i”, “TLD_j” and “TLD_k” (box 206). Each of the “SLD_X.TLD_i”, “SLD_X.TLD_j” and “SLD_X. TLD_k” displayed in the box 206 are additionally marked by using color to show if any of these domain names have been identified as having a potential conflict in the step 18 of the method in FIG. 1 described above. This way a clear message is conveyed to a user which SLD_X.TLD combinations are readily available for registration. If required, those of first level categories 202 and/or sub-categories 204 that include domain names, which have been identified as having a potential conflict, may also be marked with color or other means, to facilitate the registration process for the user. The user selects the requested “SLD_X.TLD_Y” domain name 200 and possibly other domain names from box 206, that he/she wants to register (all of which have or have not been marked with color as having potential) by checking corresponding boxes 210 associated with respective domain names, and submits his registration choices (box 208). The method then proceeds to the step 24 of the method of FIG. 1 described above.

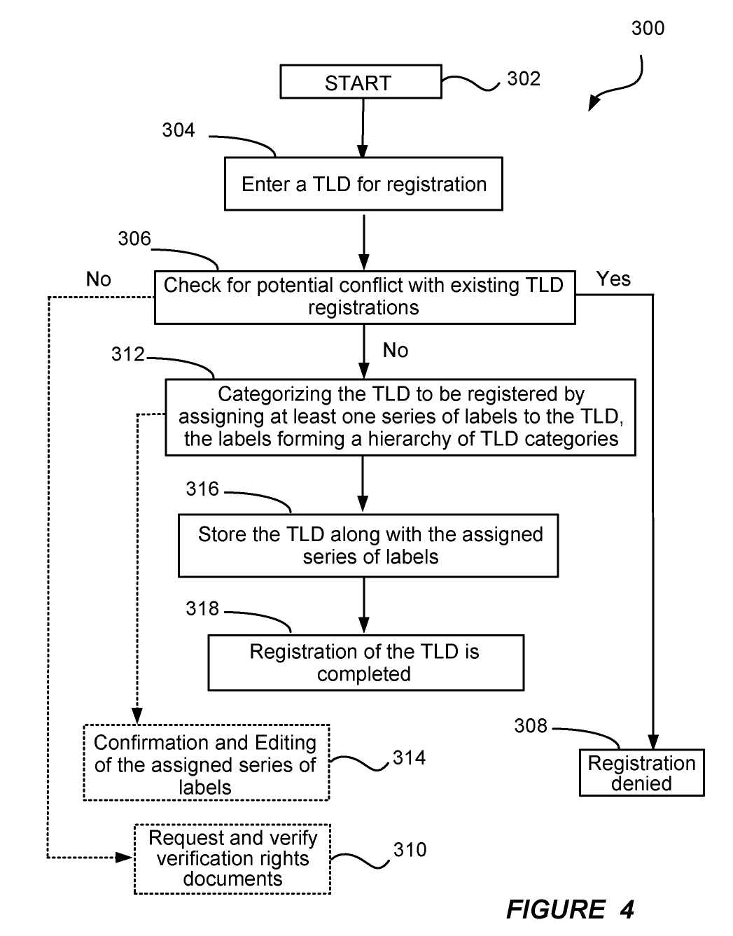

FIG. 4 shows a flowchart 300, illustrating a method for registering a TLD in the open TLD environment. Upon start (box 302), a user enters the TLD to be registered (box 304), and a registration system performs a search checking for potential conflict with other existing TLD registrations (box 306). If a potential conflict between TLDs is found, (exit “Yes” from box 306), registration is denied (box 308). If no potential conflict between TLDs has been found (exit “No” from box 306), the method proceeds to the step of categorizing the TLD to be registered by assigning one or more series of labels associated with this TLD (box 312), each series of labels optionally forming a respective hierarchy of categories associated with TLD to be registered and under which this TLD will be stored. An example of the hierarchical categories may be as follows:

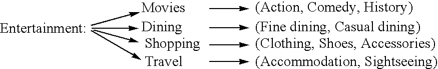

Once the TLD categorization is performed, an optional confirmation and editing of the assigned series of labels may be done, e.g. either semi-automatically, or with the involvement of a human operator (lexicographer). In this case the assigned series of labels are displayed to the lexicographer for editing and confirmation before completing the TLD registration (box 314).

Alternatively, the aforementioned series of labels may be used as simple tags of the TLD being categorized, that is, without them being used as a hierarchy of categories. In this case, domain name sub-categories labeled as 204 and 206 in FIG. 3 are omitted, and the said series of labels are used as the TLD categories labeled as 202 in FIG. 3.

Again optionally, if no potential conflict with existing TLDs has been found, verification rights documents may be requested and verified (box 310) before performing the step 312 of categorization.

The method then proceeds to the step of storing the TLD along with the assigned series of labels (box 316), at which point the TLD registration is completed (box 318).

Thus the improved methods for registering domain names in the open TLD environment have been provided.

The corresponding system for registering the TLDs and SLDs in the open TLD environment comprises a computer having a processor and memory, a web site for receiving an input data with regard to the domain name that is requested to be registered; and a program stored in the memory and executing on said computer for performing the steps of the TLD and SLD registration methods as described in detail above.

A web site for registering TLDs and SLDs in an open TLD environment is also provided, comprising a link on the web site causing a computer program code associated with the web-site and stored in a computer memory to be executed so as to provide a data input means for receiving an input data with regard to a requested domain name to be registered and to perform the TLD and SLD registration according to the steps of the methods described above.

The proposed methods and system for the TLD and SLD registration provide a expedient, convenient and reliable registration of domain names in the open TLD environment to a user.

Although the embodiments of the invention describe methods for TLD and SLD registration, it is contemplated that similar methods may be used for registering lower level domains, such as third, fourth etc level domains in the open domain name environment.

Various modifications and variations can be made to the methods described above. For example, in the step 18 of FIG. 1 for checking for potential conflict, which is expanded in more detail in FIG. 2, a verification can be done not only for exact correspondence of the requested second level domain “SLD_X” with other existing TLDs (box 100 in FIG. 2), but also for minor variations and similarities between the “SLD_X” and existing TLDs.

The arrangement and display of domain names in the form of domain name category tree (step 20 in FIG. 1) can be performed in a variety of ways, including 2D and 3D arrangement of domain names into categories and visualization of these categories by using various visualization means, including marking of the domain name categories/sub-categories etc, which have potential conflict. Conveniently, certain audio means producing one or more audio signals can be additionally used for marking the domain names categories/sub-categories having potential conflict.

The intention of this document is to provide high level system design considerations. It does not rely on any particular technologies, platforms or languages, even though some suggestions have been made along the way. It is contemplated that numerous variations and modifications to the described system and method can be made within the scope of the present invention.

What is claimed is:

1. A method for registering a second level domain “SLD_X”, in an open Top level domain (TLD) environment having a large, generally unlimited, number of TLDs, the method comprising the steps of:
(a) identifying potential conflict between the “SLD_X” and existing TLD registrations;
(b) arranging TLDs into a domain name category tree having a hierarchy of domain name categories, sub-categories etc.;
(c) displaying the domain name category tree, comprising marking all “SLD_X.TLD” domain names in the hierarchy of domain name categories that have potential conflict as identified in the step (a); and
(d) in the displayed and marked domain name category tree, selecting one or more domain names “SLD_X.TLD” for registration, the selected domain names not being marked as having potential conflict in the step (c); and
(e) registering the selected one or more domain names.

2. A system for registering the second level domain (SLD) in an open top level domain (TLD) environment, comprising:
a computer having processor and memory; and
a program stored in the memory and executing by the processor for performing the steps of the method as described in claim 1.

3. The system as described in claim 2, further comprising a web site for receiving an input data with regard to a domain name that is requested to be registered.

4. A web site for registering a SLD in an open TLD environment, comprising:
a link on the web site causing a computer program code associated with the web-site and stored in a computer memory to be executed so as to provide a data input means for receiving an input data with regard to a requested domain name to be registered and to perform the registration process according to the steps of the method of claim 1.

5. A method for registering a Top level domain (TLD) in an open top level domain environment having a large, generally unlimited, number of TLDs, the method comprising the step of categorizing the TLD to be registered by assigning at least one series of labels to the TLD.

6. The method as described in claim 5, wherein the step of categorizing comprises assigning the series of labels so that the labels are forming a hierarchy of TLD categories.
